(19) United States
(12) Patent Application Publication
(10) Pub. No.: US 2011/0122403 A1
(43) Pub. Date: May 26, 2011

(54) INSPECTION METHOD FOR BONDED WAFER USING LASER

(76) Inventors: Dong Young JANG, Seoul (KR); Seok-Kee HONG, Seoul (KR); Ho-Jin HWANG, Seoul (KR); Young-Hwan LIM, Seoul (KR); Chang-Woo BAN, Seoul (KR); Si-Eun YANG, Seoul (KR)

(21) Appl. No.: 12/951,665

(22) Filed: Nov. 22, 2010

(30) Foreign Application Priority Data
Nov. 20, 2009 (KR) 10-2009-0112347

(51) Int. Cl. G01N 21/95

(52) U.S. Cl. 356/237.1

(57) ABSTRACT

Provided is a bonded wafer inspection method using a laser method allowing a simple and reliable test in an examination of a bonded wafer interface using a laser. To do this, a laser used bonded wafer inspection method includes, emitting a laser beam through a laser means, diffusing the emitted laser beam by a laser diffusion means, illuminating the diffused laser beam on a bonded wafer, and detecting a laser beam illuminated and transmitted at the bonded wafer using a detecting means. In a case a bonded wafer inspection method using a laser of the invention is used, defects by a foreign substance occurring at an interface of a bonded wafer is can be examined in a simple way and thus high work performance may be expected.

### CROSS REFERENCE

This application claims foreign priority under Paris Convention and 35 U.S.C. §119 to Korean Patent Application No. 10-2009-0112347, filed Nov. 20, 2009 with the Korean Intellectual Property Office.

### BACKGROUND OF THE INVENTION

1. Field of the Invention

The present invention relates to a method for an interface defect of a bonded wafer, and more particularly, to a bonded wafer inspection method using a laser easy to operate based on an inspection method capable of examining interface defects of a bonded wafer using a laser apparatus.

2. Description of the Related Art

A wafer bonding method refers to technologies of bonding two of semiconductor substrates by forming silicon insulating films on the substrate surfaces, one actual wafer of such a wafer bonding method represented by an SOI (Silicon On Insulator) wafer.

The SOI wafer may be comprised of a 3-layer structure having a silicon mono crystal layer at its lower part in the overall structure and with a burial insulating layer such as an oxidizing film inserted under a silicon mono crystal layer used as an active layer becoming a device manufacturing region of an active layer with respect to a depth proceeding of a wafer.

The SOI wafer with such a structure has parasitic capacitance as small as possible, and has a characteristic of high anti-radiation capacity. Also, crystalline of SOI is superior, and has an advantage of high reliability of oxidizing film existing right below the SOI layer. And thus, the SOI wafer is expected to have a fast, low consumption power operation, and a latch-up prevention, currently highlighted.

For such a reason, a research manufacturing an SOI wafer using the bonding method has been actively performed, and through these research efforts various manufacturing methods are developed.

For instance, “SOI wafer manufacturing method” is disclosed in Korean Registration Patent Publication 10-0218541 (registered on Jul. 10, 1999).

The disclosure is related to an SOI wafer manufacturing method comprised of the step of forming an oxidizing film on an insulating substrate, the step of bonding a silicon mono crystal wafer with an oxidation film, the step of forming circularly a photoresist on a silicon mono crystal wafer, the step of etching a silicon mono crystal wafer, and the step of removing the photoresist.

And, “SOI wafer and its manufacturing method” is disclosed in Korean Registration Patent Publication 10-0498446 (registered on Jul. 22, 2005).

This relates to a technology of reducing the number of a manufacture process when manufacturing a semiconductor device using an SOI wafer and not needing an additional process such as an Epi growth, and to do this, the SOI wafer and its manufacturing method includes a first semiconductor substrate containing a device separation-end insulating film formed to define a device formation region, a well and burial layer formed per each zone in a device formation region on the first semiconductor substrate, and a second semiconductor substrate bonded to the first semiconductor substrate and formed with a bonding-end insulating film to electrically shield a lower part of the device formation region by contacting the lower part of the device separation-end insulating film.

Also, “SOI wafer manufacturing method” is disclosed in Korean Laid-open Patent application 10-2006-0069022 (published on Jul. 21, 2006).

This relates to a manufacturing method capable of manufacturing an SOI wafer excellent in dividing a hydrogen ion implant layer of a bonding wafer through a two steps low-temperature heat-processing process below 500° C. maintaining an implantation of hydrogen ion at low concentration and with noticeably low Rms values in the surface.

As mentioned above, for an SOI wafer using a wafer bonding method, various modes of manufacturing methods have been developed by devoted numerous research endeavors. However, in a bonding method using wafer, defects existing at a wafer interface, that is a wafer defect due to a foreign substance or air bubbles possibly arising between wafer interfaces has developed, and due to this a problem of lowering performance of a wafer occurs.

While such defects of a wafer can be measured using an optic microscope, an electron microscope, or an LPD (Light Point Defect) measuring instrument, these measuring device used method has a problem of difficulty in measuring precise distribution, density and size during a measuring procedure.

As an approach of solving the problems, an apparatus capable of measuring wafer's defects using an ultrasonic microscope is developed.

For example, “a defect evaluation method of an SOI wafer using an ultrasonic microscope” is disclosed in Korean Registration Patent Publication 10-0571571 (registered on Apr. 10, 2006).

This is a technology for measuring density and size, fluoric acid defects and secco defects, and non-bonding part existing in an upper silicon layer of an SOI wafer using an ultrasonic microscope, having an advantage of capable of detecting a bonding defect of a wafer as well as HF defects and secco defects. However, this technology using an ultrasonic wave comprised of a complicate structure, so that there is a trouble that an operation is not easy and the price is high.

Besides a method of measuring defects of a wafer using the ultrasonic waves, a technology using an X-ray has been developed, but this technology also has a problem due to a complicated structure in that an operation is not easy and economical burden from a high pricing arises.

Other than a wafer defect measurement using the ultrasonic or X-ray, a method of measuring defects of a wafer using IR (Infrared Ray) that is economical in the price by the ease of an operation is developed. However, in this technology, as using several filters by some technique in order to produce a wavelength band transmittable through the wafer using several numbers of filters, there exists a problem in that an output defective image of a wafer is not clear, so that a precise defect decision is difficult.

Therefore, an emerging of an examination method allowing a simple and reliable test in a defect examination of a bonded wafer interface is needed.

### SUMMARY OF THE INVENTION

Accordingly, it is an object of the present invention to provide a bonded wafer inspection method using a laser allowing a simple and reliable inspection in relation to an inspection method of a bonded wafer interface using a laser.

To achieve the above-mentioned object of the present invention, a laser using bonded wafer inspection method according to the present invention includes emitting a laser beam through a laser means containing a laser generation apparatus, a laser discernment means, and a laser light source; diffusing the emitted laser beam by a laser diffusion means; illuminating the diffused laser beam on a bonded wafer; and detecting a laser beam illuminated and transmitted on the bonded wafer using a detecting means.

When a bonded wafer inspection method using a laser according to the present invention is used, defects due to a foreign substance occurring in an interface of a bonded wafer can be checked with a simple process, thereby being expected of high work performance.

And, as another advantage, an inspection time necessary based on an inspection magnification is determined and also an interface defect inspection method of a bonded wafer capable of examining using an inspector desired magnification is provided, thus realizing an effective defect inspection according to an inspection magnification.

Furthermore, besides an interface inspection of an SOI wafer manufactured using a bonded method, it is possible to provide a bonded wafer inspection method using a laser capable of also measuring defects of such as an oxide single crystal wafer using in a cell phone and GaAs (Gallium Arsenide) wafer used in an LED.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic conceptual diagram for describing a bonded wafer inspection method using a laser according to one embodiment of the invention;

FIG. 2 is an interface image output diagram of a bonded wafer through a bonded wafer inspection method using a laser according to one embodiment of the invention;

FIG. 3 is a schematic flow diagram for describing a bonded wafer inspection method using a laser according to one embodiment of the invention;

FIG. 4 is a flow diagram indicating the step of emitting a laser beam of a bonded wafer inspection method using a laser according to one embodiment of the invention;

FIG. 5 is a flow diagram indicating a laser beam detection step of a bonded wafer inspection method using a laser according to one embodiment of the invention;

FIG. 6 is a schematic construction diagram for describing an inspection apparatus to realize a bonded wafer inspection method using a laser according to one embodiment of the invention;

FIGS. 7 thorough 9 are test chart diagrams for measuring optimal laser uniformity of an inspection apparatus for realizing a bonded wafer inspection method using a laser according to one embodiment of the invention;

FIG. 10 is an implementing diagram for describing an inspection apparatus to realize a bonded wafer inspection method using a laser according to one embodiment of the invention;

FIG. 11 is a perspective diagram of FIG. 10; and

FIG. 12 is a schematic construction diagram of a diffusion means movement member for describing an inspection apparatus to realize a bonded wafer inspection method using a laser according to one embodiment of the invention.

### DETAILED DESCRIPTION OF THE INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention.

Hereafter, a bonded wafer inspection method using a laser according to one embodiment of the invention will be described in detail with reference to the drawings.

A bonded wafer inspection method of the invention is related to a detection method using a laser of defects (for example, an air gap caused by gas, etc.) possibly occurring at an interface in a bonded wafer manufacture process.

More particularly, the bonded wafer (also called ‘bond wafer’) is defined as an interconnected wafer formed with an oxidation layer therebetween, and a bonded wafer inspection method of the present invention is an approach of inspecting defects possibly occurring in a bonded wafer manufacture process at an interface close to two of wafers.

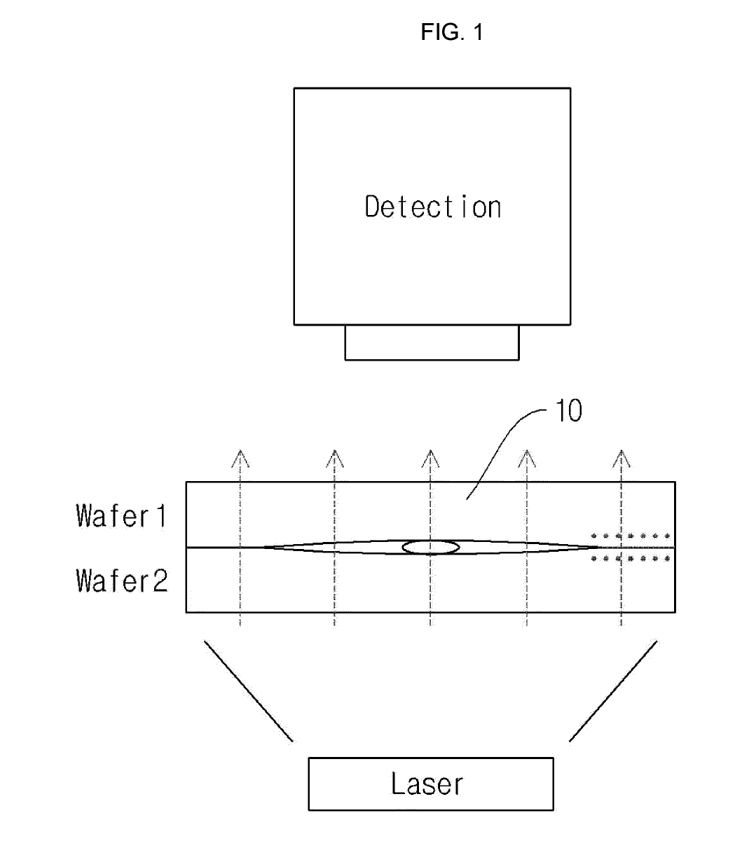

In other words, a bonded wafer inspection method of the present invention, as illustrated in FIG. 1, directs a method of detecting a defect occurrence through an image transmitted by illuminating a laser on a bonded wafer 10 manufactured to sense a defect occurrence due to a foreign substance or air bubbles between interfaces of a bond wafer bonded through the above-mentioned manufacture process.

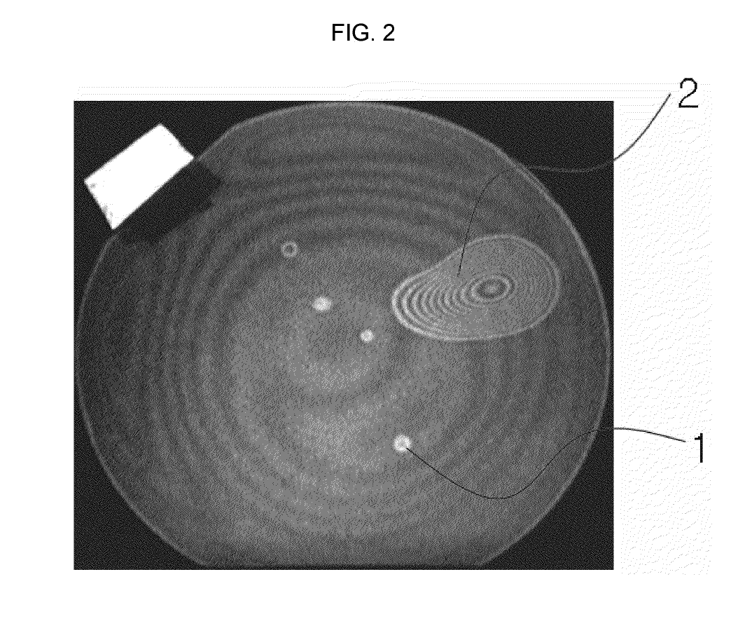

When an image transmitted through the bonded wafer 10 using a laser is detected through a later-described detection means as shown in the above FIG. 1, a defect occurrence possibly occurring at an interface of a bonded wafer can be detected as illustrated in FIG. 2. When searching based on a photographed image, it can be known that four of foreign substances 1 exist at the center vicinity of an interface, and also an air bubble 2 is formed slightly biased to the right with respect to the center point.

As described above, an inspection method of the invention directs a method of inspecting an interface of a bonded wafer through a photographed image by illuminating a laser onto a bonded wafer and photographing an image transmitted through the bonded wafer.

And thus, a bonded wafer inspection method of the invention is simple and superior in work performance compared to a conventional inspection method making use of inspection equipment utilizing an ultrasonic and an X-ray. Furthermore, a more vivid defect image output is possible compared to inspection equipment using infrared light.

In the following, a bonded wafer inspection method using a laser of the present invention having the aforementioned characteristic over conventional methods of inspecting a defect of a bonded wafer interface will be described.

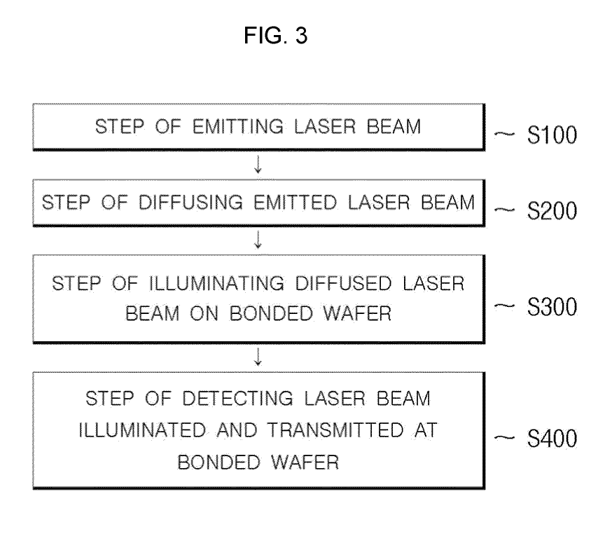

FIG. 3 is a schematic flow diagram for describing a bonded wafer inspection method using a laser according to one embodiment of the invention.

Referring to FIG. 3, a bonded wafer inspection method using a laser according to one embodiment of the invention includes the step of emitting a laser beam (S100), the step of diffusing the emitted laser beam (S200), the step of illuminating the diffused laser beam onto a bonded wafer (S300), and the step of detecting a laser beam illuminated and transmitted on the bonded wafer (S400).

More particularly, the step S200 is a step of emitting a laser beam through a laser means. And, the step S200 is a step of diffusing a laser beam emitted through the step S100. Also, the step S300 is a step of illuminating a laser beam diffused through the step S200 on a bonded wafer. Finally, the step S400 is a step of detecting an interface defect of a bonded wafer through a laser beam illuminated to the bonded wafer through the step S300 and transmitted through the bonded wafer.

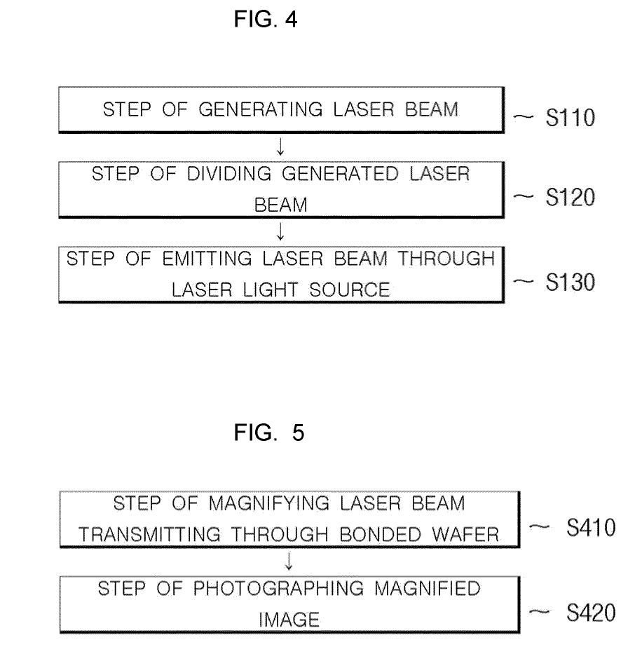

FIG. 4 is a flow diagram indicating a step of emitting a laser beam of a bonded wafer inspection method using a laser according to one embodiment of the invention.

Referring to FIG. 4, a step S100 of a bonded wafer inspection method using a laser according to one embodiment of the invention is a step of emitting a laser beam through a laser means containing a laser generation device, a laser discernment apparatus, and a laser light source, and to do this, it is preferable that the step S100 includes a step of generating a laser beam from the laser generation device S110, a step of dividing the generated laser beam through the laser discernment means S120, and a step of emitting a laser through a laser light source corresponding to the divided laser beam S130.

And, in a bonded wafer inspection method using a laser according to one embodiment of the invention, the step S100 emits a laser beam through a laser means, especially emits a laser beam having a wavelength band through which an emitted laser beam is illuminated to a bonded wafer and can transmit through the bonded wafer. To do this, a laser beam emitted through the step S100 has more than 1000 nm of a wavelength. More particularly, it is preferable to produce a laser beam having a wavelength of more than 1064 nm.

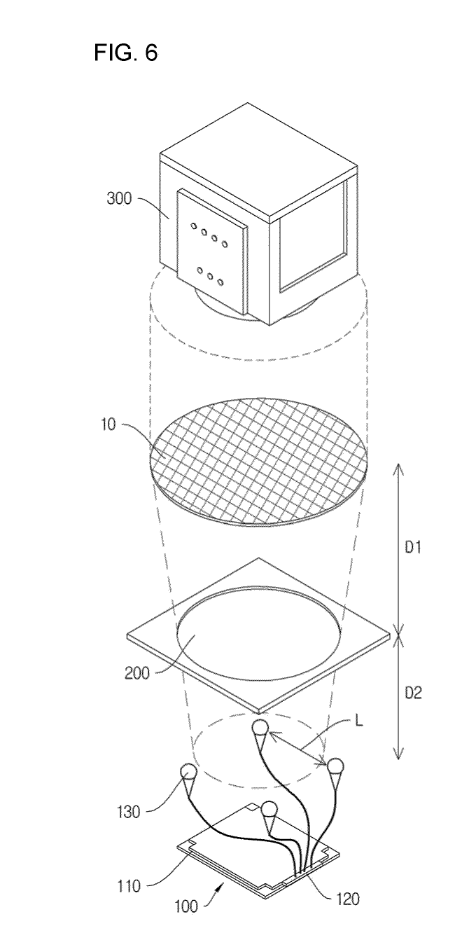

FIG. 5 is a flow diagram indicating a laser beam detection step of a bonded wafer inspection method using a laser according to one embodiment of the invention.

Referring to FIG. 5, a step S400 of a bonded wafer inspection method using a laser according to one embodiment of the invention is a step of detecting an interface defect of a bonded wafer through a laser beam transmitted through the bonded wafer, and to do this, the step S400 preferably includes a step of enlarging a laser beam transmitted through the bonded wafer using a microscope S410, and a step of photographing an image enlarged and displayed through the microscope using a camera S420.

The above-described inspection stage of the invention may be possible through a later-described bonded wafer inspection apparatus.

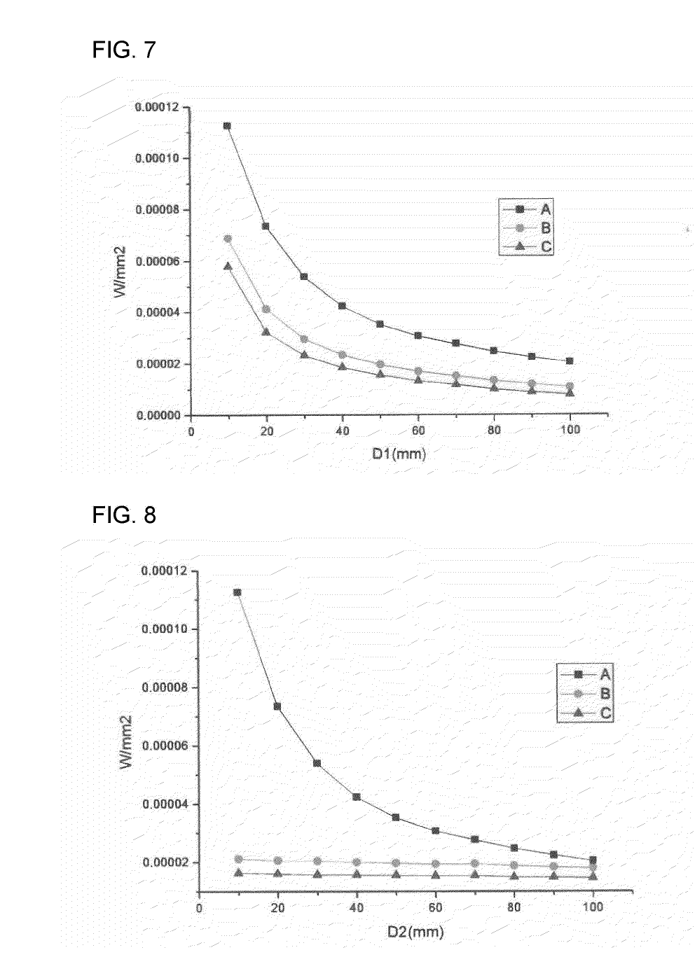

FIG. 6 is a schematic construction diagram of a bonded wafer inspection apparatus for describing a bonded wafer inspection method using a laser according to one embodiment of the invention.

Referring to FIG. 6, an inspection device for realizing a bonded wafer inspection method using a laser according to one embodiment of the invention includes a laser means 100 emitting a laser beam to a bonded wafer 10 for inspecting defects between interfaces of the bonded wafer, and it is preferred to include a laser diffusion means 200 positioned between the laser means 100 and the bonded wafer 10 possibly in order to diffuse and illuminate a laser beam emitted through the laser means 100 to the bonded wafer 10.

And, it is preferable that an inspection apparatus of the invention includes a detection means 300 detecting a defect occurrence of an interface of the bonded wafer 10 through a laser beam illuminated to the bonded wafer 10 and transmitting through the bonded wafer 10.

Hereafter, each of the components will be described in detail with reference to the drawings.

Referring to FIG. 6, an inspection device for realizing a bonded wafer inspection method using a laser according to one embodiment of the invention includes a laser means 100, in which the laser means 100 is a means emitting a laser beam for inspecting defects between interfaces of the bonded wafer to the bonded wafer, and to do this, includes a laser generation device 110, a laser discernment means 120, and a laser light source 130.

More particularly, the laser generation device 110 acts to generate a laser beam for inspecting defects between bonded wafer interfaces, wherein the laser generation device 110 generates a laser beam having a wavelength of more than 1000 nm so that a laser beam illuminated to a bonded wafer transmits through the bonded wafer, and more preferably generates a laser beam with a wavelength of more than 1064 nm.

As described above, the reason of limiting a numeric of a wavelength of a laser beam occurring from the laser generation device 110 is that a laser beam below 1000 nm area of a wavelength band does not transmit (pass through) a wafer, but only more than that of wavelength passes through a wafer.

And, the laser discernment means 120 is an apparatus of acting to separate a laser beam occurring from the laser generation device 110, and preferably, the laser discernment means 120 uses an apparatus so called an optical divider or splitter.

For one example, in a case of a monolithic optical optic-power divider is manufactured by a method of heat-bonding two strings of optic fiber in a faced way or splitting and attaching the lateral surfaces and then arranging them on a substrate, and thus manufactured optic-power divider becomes so called 1×2 optic power divider dividing one signal as two of them. 1×2 optic power divider may be connected in a cascade to make N outputs.

Because a technology of dividing light as described above is a well-known technology in the prior art, any apparatus with capacity of dividing light can be used.

Preferably, an inspection device for a bonded wafer inspection method of the present invention divides a channel of separated light into 4, 8, or 16 channels. Other than that, a divided channel number is divided according to an initial objective.

Also, the laser light source 130 acts to illuminate a laser beam occurring from the laser discernment device 110 divided through the laser discernment means 120 to the bonded wafer 10. To do this, the laser light source 130 is preferably formed by 1:1 corresponding to a number of a laser beam discerned by the laser discernment means 120.

Referring to FIG. 6, an inspection apparatus for realizing a bonded wafer inspection method using a laser according to one embodiment of the invention includes a laser diffusion means 200. The laser diffusion means 200 may be responsible for diffusing and illuminating a laser beam emitting from a laser light source 130 of the laser means 100 to the bonded wafer 10.

To this end, the laser diffusion means 200 is preferably positioned between a laser means 100 and a bonded wafer 10, and the laser diffusion means 200 is allowed to use any material capable of diffusing a laser beam, and for one example it is preferable to use a diffusion sheet.

As described above, an inspection device for realizing a bonded wafer inspection method of the present invention directs a technology of emitting a laser beam using a laser means 100, diffusing the emitted laser beam using a laser diffusion means 200 and illuminating it to the bonded wafer 10, and then detecting a laser beam illuminated passed through the bonded wafer 10 through the detection means 300, so that reliability of an image detected through the detection means 300 depending on a distance of the laser means 100, the laser diffusion means 200, and the bonded wafer 10 may be varied.

In other words, a factor capable of improving reliability of an image detected in an interface fault detection of the bonded wafer 10 is represented by a laser uniformity of an inspected area, and the laser uniformity may be decided based on an adoption of any material of laser diffusion means 200 and a distance of the laser means 100, the laser diffusion means 200, and the bonded wafer 10 may be decided based on having any kind of conditions.

Conditions for optimizing the laser uniformity can be known through a later-described experiment example. The laser uniformity may be defined by a standard deviation of a bonded light amount distribution, and the following presents a standard deviation of a light amount distribution through an experiment. (A later-described experiment uses optic design software applied with Monte-Carlo simulation.)

TABLE 1

| | Type A | Type B | Type C |
|---|---|---|---|
| Thickness | 1 mm | 0.05 mm | 1.6 mm |
| Material | glass | Plastic | Opal |
| Refractive ratio | 1.5D | 1.64D | 1.52D |
| Transmittance | 80% | 80% | 95% |
| Absorption ratio | 20% | 20% | 5% |

First, as indicated through the above Table 1, the laser diffusion means 200 is classified into 3 types for experiment. And, a laser beam emitting through a laser light source has a wavelength of 1064 nm, and the laser beam is illuminated evenly to three types of laser diffusion means.

TABLE 2

| Laser diffusion means | Type A | Type B | Type C |
|---|---|---|---|
| Inter-laser source distance (L) | 50 mm | 60 mm | 70 mm |
| Distance between laser diffusion | 50 mm | 60 mm | 70 mm |
| means and bonded wafer (D₁) | | | |
| Distance between laser source and | 50 mm | 60 mm | 70 mm |
| laser diffusion means (D₂) | | | |

As indicated through the above Table 2, each type (kind) of the laser diffusion means 200 is positioned to have a distance between laser light sources (L), a distance between the laser diffusion means 200 and the bonded wafer 10 (D₁), and a distance between the laser light source 130 and the laser diffusion means 200 (D₂).

After positioned as described above, 78 times of simulation (26 times for each of laser diffusion means) is performed before an optimization is started by illuminating a laser beam through a laser light source 130 to a wafer, and thus D₁ and D₂ vary at 10 mm interval in a range between 10 and 100 mm, L varies at 15 mm interval at between 15 and 90 mm.

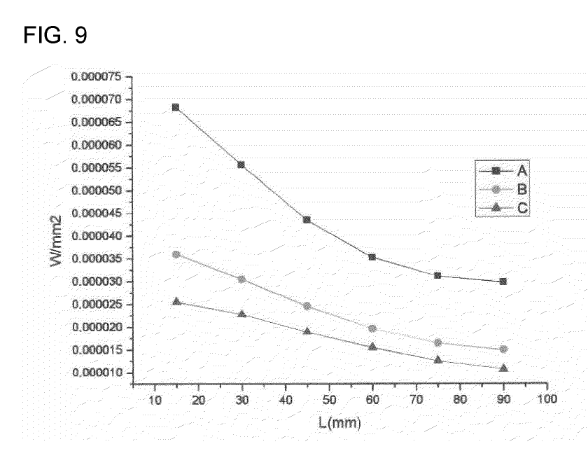

A resulting test result, as shown in FIG. 7 through FIG. 9, shows that a standard deviation of light amount distribution decreases according to a decrease of D₁ and D₂ and L values. As a standard deviation of light amount distribution varies at 50 through 70 mm of D₁ and D₂ and at 45 through 75 of L, sensitivity can be confirmed.

Referring to FIG. 6, an inspection apparatus for realizing a bonded wafer inspection method using a laser according to one embodiment of the invention includes a detecting means 300.

The detection means 300 acts to detect a defect occurrence of a bonded wafer 10 through a laser beam emitted from the laser means 100 passed through (transmitted) the bonded wafer 10. For this, it is preferred that the detection means 300 is comprised of a microscope (not shown) magnifying a laser beam transmitted through the bonded wafer 10 and a camera (not shown) photographing an image displayed through the microscope.

A laser beam transmitted through the bonded wafer 10 is magnified through the microscope, wherein a magnification ratio can be selectively varied based on an initial inspection objective, and depending on a size of magnification ratio, an inspection velocity may be determined. That is, a velocity detecting a defect of the bonded wafer 10 interface is determined by a magnification ratio through the microscope. For one example, in a case of a foreign substance of big size, the entire bonded wafer 10 may be examined using one sector, and if a foreign substance of small size, it can be examined by dividing the bonded wafer 10 into several sectors and magnifying each sector using a microscope.

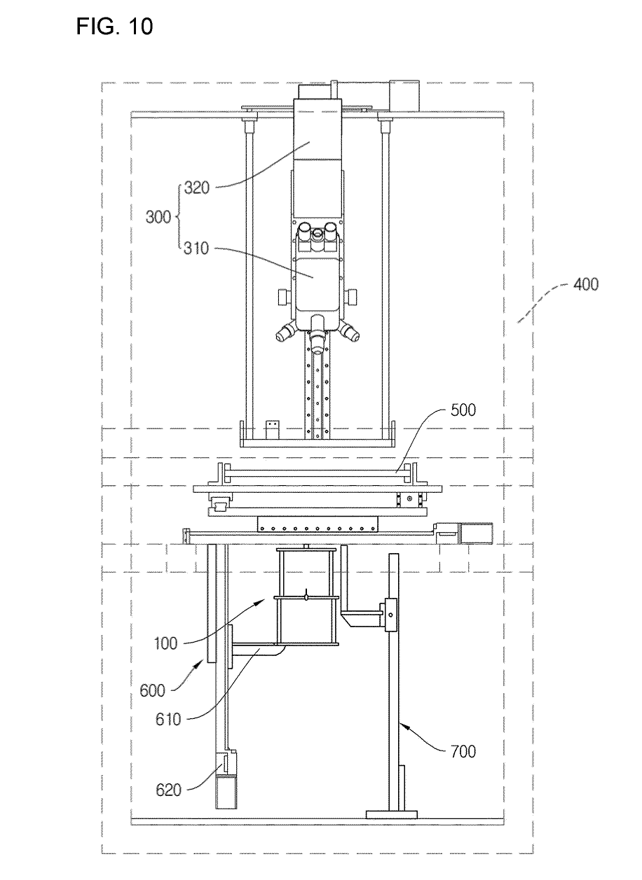

The figures of the microscope and the camera are shown through a later-described FIG. 10.

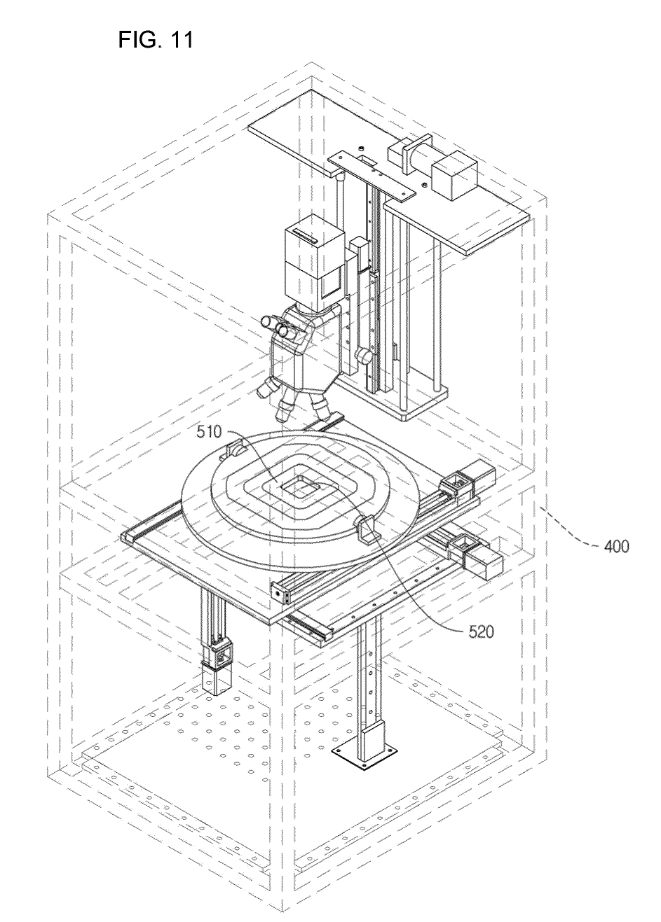

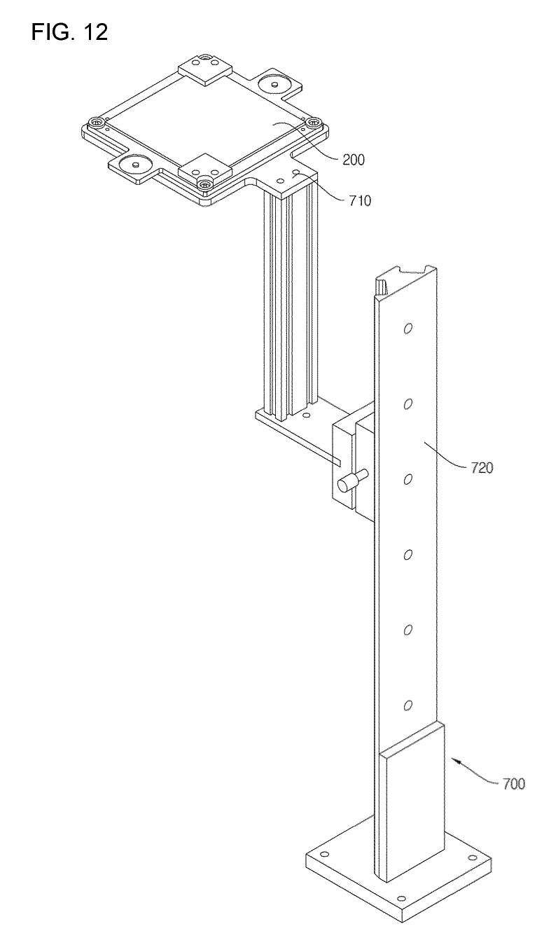

FIG. 10 is an implementing diagram for describing an inspection apparatus to realize a bonded wafer inspection method using a laser according to one embodiment of the invention, FIG. 11 is a perspective diagram of FIG. 10 and FIG. 12 is a schematic construction diagram of a diffusion means movement member for describing an inspection apparatus to realize a bonded wafer inspection method using a laser according to one embodiment of the invention.

Referring to FIGS. 10 and 12, a frame 400 fixing a laser means 100, a laser diffusion means 200, and a detection means 300 of the present invention is included, and a wafer holding part 500 holding a bonded wafer, an illumination object of a laser beam emitting through the laser means 100 is included.

Describing an inspection apparatus of the invention, first at a most bottom side, a laser means 100 containing a laser generation device 110, a laser discernment device 120, and a laser light source 130 is positioned. The laser means 100 may be placed in a fixed way to the frame 400, or it can be movably placed as later described.

That is, the laser means 100 may be designed to further include a laser means movement member 600 perpendicularly placed at one side so that the laser means 100 moves upward/downward. For this, the laser means movement member 600 preferably includes a laser means holding member 610 capable of holding the laser means 100 and a laser means guide member 620 acting as a guide thereby to move the laser means holding member 610 upward/downward.

And, in an inspection apparatus of the invention, a laser diffusion means 200 is placed at a certain distanced position from an upper part of the laser means 100. The laser diffusion means 200 may be fixed placed by the frame 400, and as shown in FIG. 12, it can be movable by further including a separate laser diffusion means movement member 700.

For this, the laser diffusion means movement member 700 preferably includes a laser diffusion means holding member 710 capable of holding the laser diffusion means 200 and a laser diffusion means guide member 720 acting as a guide thereby to move the laser diffusion means holding member 710 upward/downward.

Also, in the inspection device of the present invention, a wafer holding part 500 holding a bonded wafer is placed at a certain distanced position from an upper part of the laser diffusion means 200.

The wafer holding part 500 preferably includes a support part 510 supporting a surrounding edge of a bonded wafer for holding the bonded wafer and a hole 520 formed at the center so that a laser beam transmits the bonded wafer.

Also, the wafer holding part 500 is preferably designed to possibly adjust the diameter of a hole formed at the center corresponding to a diameter of a wafer held in order to holding without restraint to a size of a held wafer. For this, the wafer holding part 500 is preferably designed to be composed of coupling of a multiple of wafer holding parts 500 matching to a size of a wafer held as shown in FIG. 11.

Furthermore, in an inspection device of the present invention, a detection means 300 containing a microscope 310 and a camera 320 is placed at a certain distanced distance from the wafer holding part 500 upper part. The detection means 300 may be fixed placed by the frame 400, and it may be designed to be possibly upward/downward movable using a separate movement means.

As described above, an upward/downward drive of each movement member, that is a laser means movement member 600, and a laser diffusion means movement member 700 may be preferably controlled using an additional motor. More particularly, each movement member using one motor may be controlled, or it may be designed to have a motor at each movement member.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A bonded wafer inspection method using a laser, the method comprising:
emitting a laser beam through a laser means containing a laser generation device, a laser discern means, and a laser light source;
diffusing the emitted laser beam by a laser diffusion means;
illuminating the diffused laser beam on a bonded wafer; and
detecting a laser beam illuminated and transmitted at the bonded wafer using a detecting means.

2. The method of claim 1, wherein the step of emitting a laser beam through a laser means includes,
emitting a laser beam from a laser generation apparatus;
dividing the generated laser beam through a laser discern means; and
emitting a laser through a laser light source corresponding to the divided laser beam.

3. The method of claim 1, wherein a laser beam emitting through the laser means has a wavelength of more than 1000 nm to transmit a bonded wafer.

4. The method of claim 1, wherein the step of detecting a laser beam transmitted includes,
magnifying a laser beam transmitted through the bonded wafer using a microscope; and
photographing an image magnified and displayed through the microscope using a camera.

5. The method of claim 2, wherein in the step of emitting a laser beam through a laser means, a distance between laser light sources corresponding to the divided laser beam is 75 mm, and in the step of diffusing the laser beam by a laser diffusion means, a distance between the laser light source and the laser diffusion means is 70 mm, and in the step of illuminating the laser beam onto a bonded wafer, a distance between the laser diffusion means and the bonded wafer is 70 mm.
